(19) United States
(12) Patent Application Publication
(10) Pub. No.: US 2026/0275944 A1
(43) Pub. Date: Sep. 17, 2026

(54) GAS FUEL INJECTION VALVE AND FUEL INJECTION SYSTEM

(71) Applicant: DENSO CORPORATION, Kariya-city (JP)

(72) Inventors: Takashi FURUKAWA, Kariya-city (JP); Asuka SASAKI, Kariya-city (JP)

(21) Appl. No.: 19/669,243

(22) Filed: May 6, 2026

Related U.S. Application Data
(63) Continuation of application No. PCT/JP2024/036780, filed on Oct. 16, 2024.

(30) Foreign Application Priority Data
Nov. 10, 2023 (JP) 2023-192394

(51) Int. Cl. F02M 21/02

(52) U.S. Cl. CPC F02M 21/0269; F02M 21/0254

(57) ABSTRACT

A fuel injection valve includes: a main body that has an injection hole; a valve element that opens and closes the injection hole; a spring member that urges the valve element; a stationary core; a first movable core that is attracted to the stationary core by a drive magnetic flux at a time of fuel injection and thereby lifts the valve element from a valve closing position to a first lift position; and a second movable core that is attracted to the stationary core by the drive magnetic flux to further lift the valve element from the first lift position to a second lift position. Further, at the end of the fuel injection, the valve element is returned from the second lift position to the first lift position, and is temporarily stopped at the first lift position, and is then returned to the valve closing position.

### CROSS REFERENCE TO RELATED APPLICATIONS

This application is a continuation application of International Patent Application No. PCT/JP2024/036780 filed on Oct. 16, 2024, which designated the U.S. and claims the benefit of priority from Japanese Patent Application No. 2023-192394 filed on Nov. 10, 2023. The entire disclosures of all of the above applications are incorporated herein by reference.

### TECHNICAL FIELD

The present disclosure relates to a gas fuel injection valve and a fuel injection system.

### BACKGROUND

As a gas fuel injection valve used for a direct-injection gas engine, for example, a gas metering valve has been proposed. The gas metering valve includes: a valve member that is configured to open an inflow opening of a gas chamber; and a shut-off valve that is disposed on a downstream side of the valve member, specifically disposed between the valve member and an outflow opening of the gas chamber. The valve member, which is disposed on the upstream side, is moved toward a valve opening side by a magnetic attractive force of an electromagnet, and the shut-off valve disposed on the downstream side is moved toward the valve opening side due to pressure balance after the opening of the valve member. Further, when the valve member, which is disposed on the upstream side, is moved toward the valve opening side by the magnetic attractive force of the electromagnet, the shut-off valve is moved toward the valve opening side in mechanical linkage with the valve member.

### SUMMARY

According to the present disclosure, there is provided a gas fuel injection valve that is configured to inject a gas fuel. The gas fuel injection valve may include a main body, a valve element, a spring member, a stationary core, a first movable core and a second movable core. The main body may have a fuel passage and an injection hole. The fuel passage may be configured to conduct the gas fuel. The injection hole may be configured to inject the gas fuel received in the fuel passage. The valve element may be configured to open and close the injection hole. The spring member may be configured to urge the valve element in a valve closing direction. The stationary core may be fixed to the main body. The first movable core may be configured to be attracted to the stationary core at a time of fuel injection in response to generation of a drive magnetic flux and thereby lift the valve element from a valve closing position to a first lift position. The second movable core, subsequent to lifting of the valve element to the first lift position by the first movable core, may be configured to be attracted to the stationary core by the drive magnetic flux to further lift the valve element from the first lift position to a second lift position at which a lift amount of the valve element is greater than at the first lift position. The valve element may be driven at an end of the fuel injection such that the valve element is returned from the second lift position to the first lift position, and is temporarily stopped at the first lift position, and is then returned to the valve closing position by an urging force of the spring member.

### BRIEF DESCRIPTION OF DRAWINGS

The drawings described herein are for illustrative purposes only of selected embodiments and not all possible implementations, and are not intended to limit the scope of the present disclosure.

FIG. 1 is a longitudinal cross-sectional view of a fuel injection valve.

FIG. 2 is a transverse cross-sectional view of the fuel injection valve.

FIG. 3 is an explanatory diagram showing a relationship between a stationary core and respective movable cores.

FIG. 4 is a diagram for explaining an operation at the valve opening time of the fuel injection valve.

FIG. 5 is a diagram for explaining an operation at the valve closing time of the fuel injection valve.

FIG. 6 is a flowchart showing a solenoid energization control process.

FIG. 7 is a diagram showing a relationship between pressure of a gas fuel and a time period TA.

FIG. 8 is a time chart showing, during opening and closing of the fuel injection valve, changes in the lift amount of each movable core, changes in the applied current, and changes in the injection rate.

FIG. 9 is a time chart showing a valve element speed at the valve closing time of a valve element.

FIG. 10 is a longitudinal cross-sectional view of a fuel injection valve according to a second embodiment.

FIG. 11 is a longitudinal cross-sectional view of the fuel injection valve in a valve opening state according to the second embodiment.

FIG. 12 is a flowchart showing an energization control process of a solenoid coil according to the second embodiment.

FIG. 13 is a longitudinal cross-sectional view of a fuel injection valve according to another example.

### DETAILED DESCRIPTION

As a gas fuel injection valve used for a direct-injection gas engine, for example, a gas metering valve has been proposed. The gas metering valve includes: a valve member that is configured to open an inflow opening of a gas chamber; and a shut-off valve that is disposed on a downstream side of the valve member, specifically disposed between the valve member and an outflow opening of the gas chamber. The valve member, which is disposed on the upstream side, is moved toward a valve opening side by a magnetic attractive force of an electromagnet, and the shut-off valve disposed on the downstream side is moved toward the valve opening side due to pressure balance after the opening of the valve member. Further, when the valve member, which is disposed on the upstream side, is moved toward the valve opening side by the magnetic attractive force of the electromagnet, the shut-off valve is moved toward the valve opening side in mechanical linkage with the valve member.

In the gas fuel injection valve, since it is desirable to increase an injection rate of a gas fuel having a large specific volume, increasing the lift amount of a valve element has been considered. However, in a configuration in which the lift amount of the valve is increased, at the time of closing a valve element from a valve opening position, the impact, which is generated at the time of abutting the valve element against a seat surface, becomes large, raising concern that wear of the valve element will occur. There is also concern that leakage of the gas fuel will occur due to wear of the valve element.

The present disclosure is made in view of the above circumstances, and it is an objective of the present disclosure to provide a gas fuel injection valve and a fuel injection system that can achieve a high flow rate of a gas fuel while achieving protection of a valve element.

According to the present disclosure, there is provided a gas fuel injection valve that is configured to inject a gas fuel, the gas fuel injection valve including:

a main body that has:

a fuel passage which is configured to conduct the gas fuel; and

an injection hole which is configured to inject the gas fuel received in the fuel passage;

a valve element that is configured to open and close the injection hole;

a spring member that is configured to urge the valve element in a valve closing direction;

a stationary core that is fixed to the main body;

a first movable core that is configured to be attracted to the stationary core at a time of fuel injection in response to generation of a drive magnetic flux and thereby lift the valve element from a valve closing position to a first lift position; and

a second movable core that, subsequent to lifting of the valve element to the first lift position by the first movable core, is configured to be attracted to the stationary core by the drive magnetic flux to further lift the valve element from the first lift position to a second lift position at which a lift amount of the valve element is greater than at the first lift position, wherein:

the valve element is driven at an end of the fuel injection such that the valve element is returned from the second lift position to the first lift position, and is temporarily stopped at the first lift position, and is then returned to the valve closing position by an urging force of the spring member.

In the gas fuel injection valve of the above configuration, at the time of the fuel injection, the first movable core is attracted to the stationary core in response to the generation of the drive magnetic flux, thereby lifting the valve element from the valve closing position to the first lift position. Furthermore, subsequent to the lifting of the valve element to the first lift position by the first movable core, the second movable core is attracted to the stationary core by the drive magnetic flux to further lift the valve element from the first lift position to the second lift position at which the lift amount of the valve element is greater than at the first lift position. Thus, a two-stage lift of the valve element is performed, enabling the high flow rate of the gas fuel.

Further, at the end of the fuel injection, the valve element is returned from the second lift position to the first lift position, and is temporarily stopped at the first lift position, and is then returned to the valve closing position by the urging force of the spring member. In this case, the valve element does not move all at once from the maximum opening degree (i.e., the second lift position) to the valve closing position, but instead temporarily stops at the intermediate position (i.e., the first lift position) and is then returned to the valve closing position. Therefore, the impact at the time when the valve element abuts against the seat surface can be reduced, and the wear of the valve element can be suppressed. As a result, it is possible to achieve the protection of the valve element while achieving the high flow rate of the gas fuel.

### First Embodiment

Hereinafter, the first embodiment of the present disclosure for a gas fuel injection valve will be described with reference to the drawings. The gas fuel injection valve of the present embodiment is applicable to a direct-injection gas engine (internal combustion engine) that uses a gas fuel such as hydrogen, compressed natural gas (CNG) or liquefied natural gas (LNG), and the gas fuel is directly injected into a combustion chamber of the gas engine by the gas fuel injection valve. The gas engine is, for example, an in-vehicle engine. The fuel injection system, which includes the gas fuel injection valve in the present embodiment, is a so-called low-pressure direct injection system in which the gas fuel compressed to several MPa is injected from the fuel injection valve into the combustion chamber.

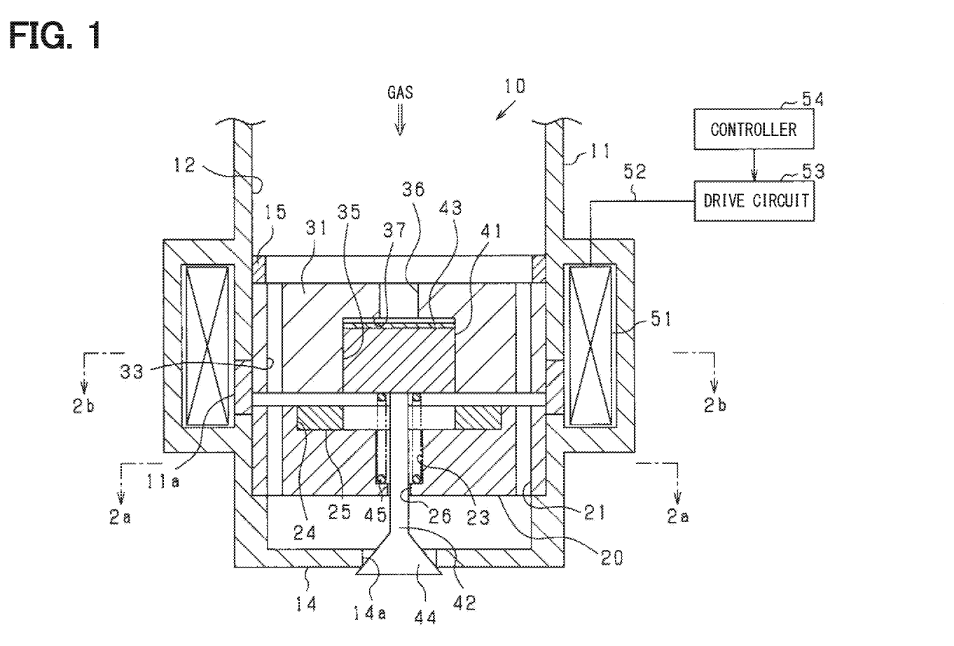

A configuration of the fuel injection valve 10 will be described with reference to FIG. 1. FIG. 1 shows a longitudinal cross-sectional view of a structure of a principal portion of the fuel injection valve 10. In the following explanation, a direction, in which a central axis of the fuel injection valve 10 extends (that is, an up-down direction in FIG. 1), is defined as an axial direction, and a direction, which extends radially from the axis, is defined as a radial direction. Furthermore, a direction, which extends circumferentially about the axis, is defined as a circumferential direction. In FIG. 1, an upper side is a base end side (an upstream side) of the fuel injection valve 10, and a lower side is a distal end side (a downstream side).

The fuel injection valve 10 includes a housing 11. The housing 11 is formed in a tubular shape and has a fuel passage 12 therein. The housing 11 is made of a magnetic material, and a non-magnetic portion 11a, which is made of a non-magnetic material, is interposed at an axial intermediate portion of the housing 11. The housing 11 has a hollow portion formed in a cylindrical shape, and the fuel passage 12 is formed by the hollow portion so as to extend in the axial direction. The gas fuel is supplied to the fuel passage 12 from an axial base end side (the upper side in the drawing). In a case where hydrogen gas is used as the gas fuel, the gas fuel compressed to about 3 MPa is supplied from a fuel supply portion, which is disposed on the upstream side, to the fuel passage 12. The housing 11 serves as a main body.

The housing 11 has an end plate portion 14 at its axial distal end portion, and an injection hole 14a for injecting the gas fuel into the engine combustion chamber is provided in the end plate portion 14. The injection hole 14a is provided at a center of the end plate portion 14. The fuel injection valve 10 is assembled to the gas engine such that the end plate portion 14 is exposed in the combustion chamber. The end plate portion 14 is not necessarily required to have a flat plate shape, which extends in a direction perpendicular to the axial direction as illustrated, and may have, for example, a conical shape that is convex toward the distal end side.

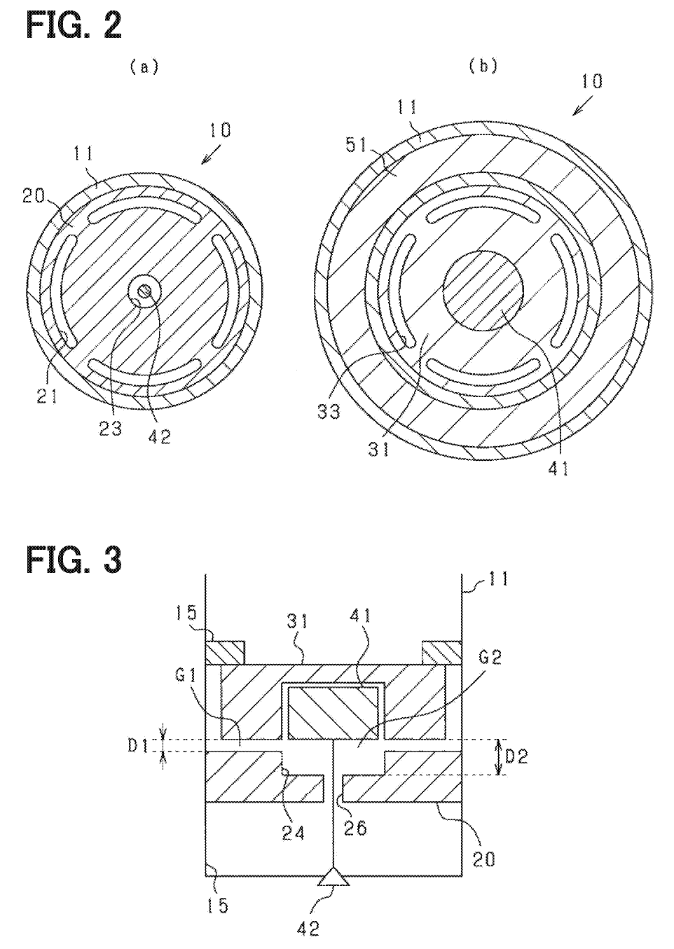

A stationary core 20 made of a magnetic material is fixed inside the housing 11. The stationary core 20 has a plurality of communication passages 21 that communicate between an upstream side and a downstream side of the stationary core 20. In the fuel passage 12, the flow of the gas fuel from the upstream side to the downstream side of the stationary core 20 is enabled through the communication passages 21. In FIG. 2, (a) is a cross-sectional view taken along line 2a-2a in FIG. 1. As shown in this cross-sectional view, the stationary core 20 has the communication passages 21 which are respectively formed in an arcuate shape and are arranged in the circumferential direction. Here, it should be noted that a shape of an opening of each communication passage 21 may be any shape.

In the fuel passage 12, a first movable core 31 and a second movable core 41 are disposed on the upstream side of the stationary core 20, i.e., on the side of the stationary core 20, which is opposite to the injection hole 14a in the axial direction. These movable cores 31, 41 are each made of a magnetic material.

The first movable core 31 is reciprocally movable in the axial direction in the fuel passage 12 along an inner peripheral surface of the housing 11. The first movable core 31 has a plurality of communication passages 33 that communicate through the first movable core 31 in the axial direction. In FIG. 2, (b) is a cross-sectional view taken along line 2b-2b in FIG. 1. As shown in this cross-sectional view, the first movable core 31 has the communication passages 33 which are respectively formed in the arcuate shape and are arranged in the circumferential direction. It is preferable that each of the communication passages 33 is provided at a position where the communication passage 33 is continuous in the axial direction relative to a corresponding one of the communication passages 21 of the stationary core 20.

The housing 11 is provided with a position limiting portion 15 that limits an axial position of the first movable core 31. The first movable core 31 is movable in the axial direction between the position limiting portion 15 and the stationary core 20. A downstream-side end surface of the first movable core 31 and an upstream-side end surface of the stationary core 20 are opposed to each other in a state where the downstream-side end surface of the first movable core 31 and the upstream-side end surface of the stationary core 20 are parallel to each other.

A recess 35, which opens on the downstream side, is formed in the first movable core 31, and the second movable core 41 is provided in a state where the second movable core 41 is installed in the recess 35 of the first movable core 31. Accordingly, the second movable core 41 is movable integrally with the first movable core 31 toward the valve opening side (the lower side in FIG. 1). The first movable core 31 is formed in a bottomed tubular shape and has a hollow portion inside the first movable core 31, and the second movable core 41 is received in the hollow portion in a state in which the second movable core 41 is movable in the hollow portion. The second movable core 41 is reciprocally movable in the recess 35 in the axial direction relative to the first movable core 31.

Both the recess 35 of the first movable core 31 and the second movable core 41 have a circular shape in a cross section thereof, and the second movable core 41 is received inside the first movable core 31 which has a circular ring shape. In this case, the upstream-side end surface of the second movable core 41 is opposed to a bottom (an axial end surface) of the recess 35. When the first movable core 31 is moved toward the valve opening side, the first movable core 31 abuts against the second movable core 41, and thereafter the first movable core 31 and the second movable core 41 are moved together toward the valve opening side.

The first movable core 31 has a through hole 36 that extends through the first movable core 31 in the axial direction and is communicated with the recess 35. This allows the gas fuel to flow into a rear side of the second movable core 41. In the first movable core 31, the through hole 36 has a reduced diameter that is reduced in comparison to that of the recess 35, and a step portion, which is formed by the recess 35 and the through hole 36, serves as a contact portion 37 that contacts the second movable core 41 when the first movable core 31 and the second movable core 41 are moved together.

A non-magnetic portion 43, which is formed in a sheet shape and is made of a non-magnetic material, is provided on the upstream-side end surface of the second movable core 41. It is only required that the non-magnetic portion 43 is located between the bottom surface of the recess 35 of the first movable core 31 and the second movable core 41 and is provided to at least one of the bottom surface of the recess 35 of the first movable core 31 and the second movable core 41.

A valve element 42, which opens and closes the injection hole 14a, is integrated with the second movable core 41. The valve element 42 is formed in a needle shape and extends in the axial direction from a downstream-side end surface of the second movable core 41. The valve element 42 is arranged in a state where the valve element 42 is inserted through an insertion hole 26 of the stationary core 20. The valve element 42 is an outward-opening valve that is brought into a valve opening state when the valve element 42 is moved toward an outside of the housing 11.

The valve element 42 has a distal end valve portion 44 at an axial distal end portion of the valve element 42. The valve element 42 is arranged in a state where the valve element 42 is inserted through the injection hole 14a, and the distal end valve portion 44 closes the injection hole 14a from the housing outside. In this case, the injection hole 14a is opened when the distal end valve portion 44 is moved away from the end plate portion 14. It is preferable that the valve element 42 is made of a metal material, a non-metal material, or another non-elastomer material having excellent heat resistance. In the case where the valve element 42 has the outward-opening valve structure, inflow of flame and combustion pressure from the engine combustion chamber into the injection valve is suppressed.

A spring 45, which serves as a spring member and is made of a compression coil spring, is provided between the second movable core 41 and the stationary core 20. The spring 45 urges the second movable core 41 toward a side away from the stationary core 20, that is, toward a side where the distal end valve portion 44 of the valve element 42 closes the injection hole 14a (a valve closing side). A spring receiving portion 23 is formed in the stationary core 20 at a location that surrounds a shaft of the valve element 42, and the spring 45 is provided in a state where the spring 45 is received in the spring receiving portion 23.

Additionally, a recess 24 is recessed in the upstream-side end surface of the stationary core 20 at a center portion thereof that is centered in a transverse cross section of the stationary core 20. The recess 24 is provided at a location axially opposed to the second movable core 41 and is sized so as to be able to receive a distal end portion of the second movable core 41. A non-magnetic portion 25, which is formed in a circular ring shape and is made of a non-magnetic material, is provided on an inner peripheral surface of the recess 24 in the stationary core 20.

Since the second movable core 41 is urged toward the valve closing side by the spring 45, the distal end valve portion 44 of the valve element 42 closes the injection hole 14a, and an air gap is formed between the second movable core 41 and the bottom surface of the recess 24 of the stationary core 20.

In addition to the spring 45, which is provided between the second movable core 41 and the stationary core 20, it is also possible to adopt a configuration in which a spring (compression coil spring) is provided between the first movable core 31 and the stationary core 20.

Both the first movable core 31 and the second movable core 41 are opposed to the stationary core 20 from the axial upstream side of the stationary core 20, but separation distances (air gap dimensions) of their respective air gaps differ, and this configuration will be further described with reference to FIG. 3. FIG. 3 is an explanatory diagram showing a relationship between the stationary core 20 and the respective movable cores 31, 41. In FIG. 3, illustration of the communication passages 21, 33 of the stationary core 20 and the first movable core 31 is omitted.

As shown in FIG. 3, an air gap G1 is formed between the downstream-side end surface of the first movable core 31 and the upstream-side end surface of the stationary core 20, and an air gap G2 is formed between the downstream-side end surface of the second movable core 41 and the upstream-side end surface (specifically, the bottom surface of the recess 24) of the stationary core 20. The separation distance D1 of the air gap G1 and the separation distance D2 of the air gap G2 are set to be D1 < D2. In this case, the first movable core 31 can move in the axial direction by a maximum distance that is equal to the separation distance D1, and the second movable core 41 can move in the axial direction by a maximum distance that is equal to the separation distance D2.

In FIGS. 1 and 3, the downstream-side end surface of the first movable core 31 and the downstream-side end surface of the second movable core 41 are flush with each other in an initial state (non-operating state), but the structure is not limited to this configuration. For example, the downstream-side end surface of the second movable core 41 may be configured so as to be recessed deeper than the downstream-side end surface of the first movable core 31 toward the bottom side of the recess, or the downstream-side end surface of the second movable core 41 may be configured so as to protrude further outward of the recess than the downstream-side end surface of the first movable core 31. In any case, it is sufficient as long as the relationship between the separation distance D1 of the air gap G1 and the separation distance D2 of the air gap G2 satisfies D1 < D2.

In the fuel injection valve 10, a solenoid coil 51 is provided at a location that surrounds the first movable core 31 and the stationary core 20. The solenoid coil 51 is provided at a position that overlaps, in the axial direction, the stationary core 20 and each of the movable cores 31, 41.

In addition to the fuel injection valve 10, the fuel injection system of the present embodiment includes: a drive circuit 53, which energizes the solenoid coil 51; and a controller 54, which controls the fuel injection of the fuel injection valve 10. In the fuel injection system, the drive circuit 53 is connected to the solenoid coil 51 via a harness 52. Energization by the drive circuit 53 is controlled by the controller 54. The controller 54 includes a microcomputer that has a CPU (processor) and various types of memories. During the engine operation, the controller 54 outputs an energization signal to the drive circuit 53 in accordance with a combustion cycle of each cylinder, thereby causing the fuel injection valve 10 to inject fuel.

Further, in the fuel injection system of the present embodiment, the pressure of the gas fuel supplied to the fuel injection valve 10, i.e., the injection pressure is variably adjusted, and the controller 54 controls the pressure of the gas fuel based on, for example, the operational state of the gas engine. The pressure of the gas fuel is set to, for example, a range of about 0.5 to 5 MPa.

In the fuel injection valve 10, magnetic energy is generated by energizing the solenoid coil 51 through the drive circuit 53, and the first movable core 31 and the second movable core 41 are attracted to the stationary core 20 by this magnetic energy. As a result, the valve element 42 moves to a valve opening position, and the gas fuel is injected from the injection hole 14a. In the present embodiment, the single solenoid coil 51 drives the two movable cores 31, 41 simultaneously toward the valve opening side.

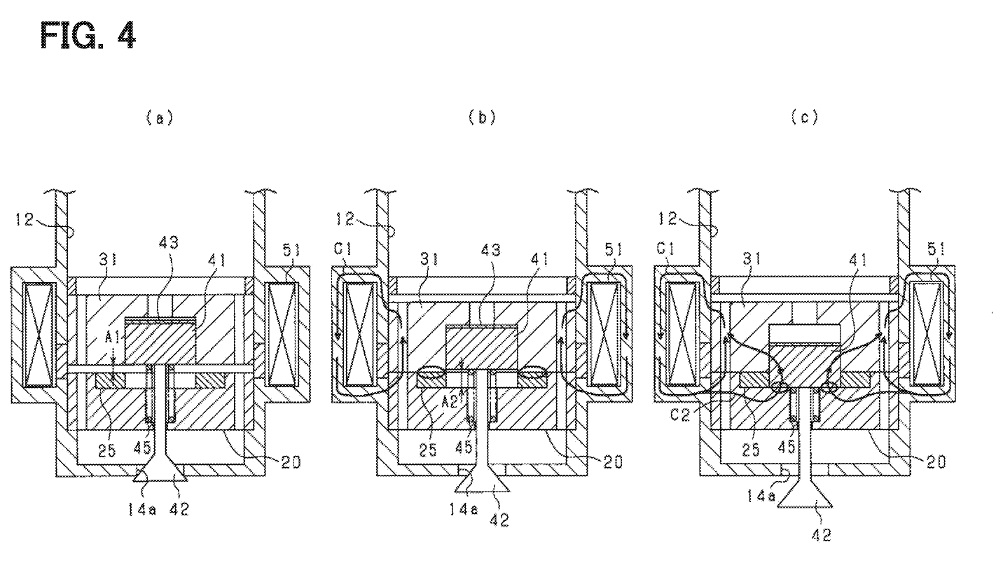

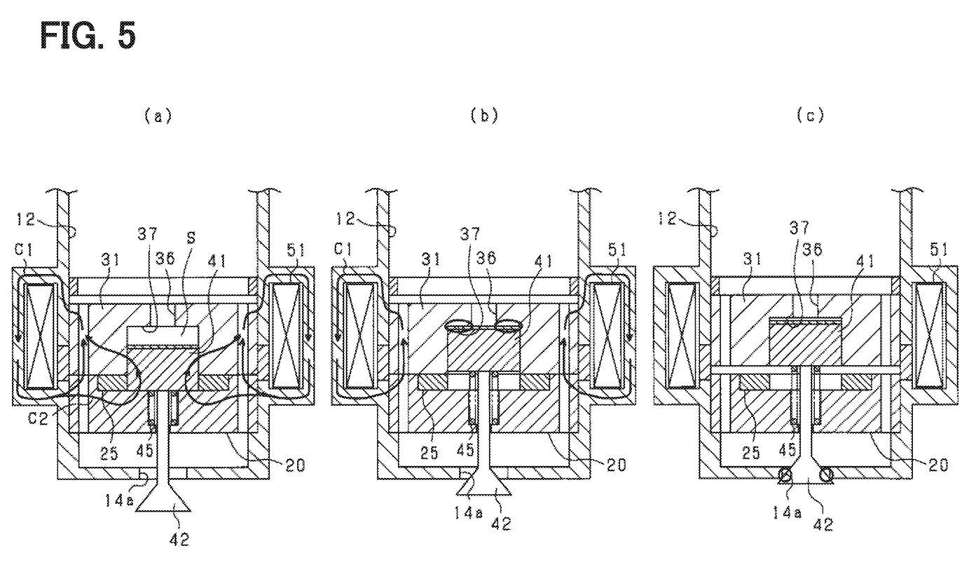

Next, the operations at the valve opening time and the valve closing time of the fuel injection valve 10 will be explained in detail. Here, (a) to (c) of FIG. 4 are diagrams for explaining the operation at the valve opening time of the fuel injection valve 10, and (a) to (c) of FIG. 5 are diagrams for explaining the operation at the valve closing time of the fuel injection valve 10.

First, the operation at the valve opening time of the fuel injection valve 10 will be explained with reference to (a) to (c) of FIG. 4. Here, (a) of FIG. 4 shows an initial state, and energization to the solenoid coil 51 is started in this state. As a result, as shown in (b) of FIG. 4, a drive magnetic flux is generated, and a magnetic circuit is formed along a first magnetic flux path indicated by an arrow C1 in the drawing, and a magnetic attractive force is exerted between the first movable core 31 and the stationary core 20 to attract each other. Then, the first movable core 31 is attracted to the stationary core 20, and thereby the second movable core 41 moves together with the first movable core 31. Thus, the valve element 42 is lifted from the valve closing position to a first lift position. At this time, the separation distance D1 between the first movable core 31 and the stationary core 20 and the separation distance D2 between the second movable core 41 and the stationary core 20 are different from each other in the initial state (see FIG. 3). Then, in an initial stage of the energization of the solenoid coil 51, a magnetic circuit is formed through a path that passes through the first movable core 31 which has the smaller separation distance D1 relative to the stationary core 20 than the separation distance D2 of the second movable core 41 relative to the stationary core 20. As a result, at the initial stage of the energization, the magnetic flux flows concentratedly along the first magnetic flux path C1 including the first movable core 31, thereby enhancing the responsiveness of the attraction movement of the first movable core 31.

Furthermore, in the fuel injection valve 10, the first movable core 31 is disposed inside the solenoid coil 51, and the second movable core 41 is disposed inside the first movable core 31. That is, the first movable core 31 is disposed on the radially outer side of the second movable core 41, that is, the first movable core 31 is disposed closer to the solenoid coil 51 than the second movable core 41. Therefore, at the initial stage of energization of the solenoid coil 51, the first movable core 31 experiences a stronger magnetic attractive force toward the stationary core 20 than does the second movable core 41, thereby enhancing the responsiveness of the attraction movement of the first movable core 31.

Further, the non-magnetic portion 43 is interposed between the surface of the first movable core 31 and the surface of the second movable core 41 which are opposed to each other in the axial direction. In the state shown in (a) of FIG. 4 and the state shown in (b) of FIG. 4, the non-magnetic portion 43 functions as a magnetic flux restricting portion that restricts the flow of the magnetic flux that passes through between the first movable core 31 and the second movable core 41. As a result, the passing of the magnetic flux through the unintended path is suppressed, and thereby the magnetic flux is caused to flow intensively through the first magnetic flux path C1.

In the state shown in (b) of FIG. 4, the first movable core 31 is brought into contact (seated) with the stationary core 20, and the separation distance between the second movable core 41 and the stationary core 20 is reduced relative to (a) of FIG. 4. Further, the second movable core 41 is moved together with the first movable core 31 toward the valve opening side until the first movable core 31 contacts the stationary core 20. After the first movable core 31 contacts the stationary core 20, the second movable core 41 moves alone toward the valve opening side due to its inertia. Therefore, the separation distance between the second movable core 41 and the stationary core 20 is reduced, and a magnetic circuit is formed by a second magnetic flux path indicated by an arrow C2 in addition to the first magnetic flux path indicated by the arrow C1, thereby generating a magnetic attractive force between the second movable core 41 and the stationary core 20 to attract each other.

As a result, as shown in (c) of FIG. 4, the second movable core 41 is attracted to the stationary core 20, and the second movable core 41 is seated on the stationary core 20. In this state, both the first movable core 31 and the second movable core 41 seat on the stationary core 20, and the valve element 42 is lifted from the first lift position shown in (b) of FIG. 4 to a second lift position shown in (c) of FIG. 4. Thus, the valve element 42 provides the injection hole 14a with its maximum opening degree. The state shown in (c) of FIG. 4 is maintained by continuing the energization of the solenoid coil 51.

Here, due to the presence of the communication passages 21, a radial wall thickness of a portion of the stationary core 20, which is opposed to the first movable core 31, is reduced, thereby forming a magnetic constriction. In this case, magnetic saturation occurs at the magnetic constriction of the stationary core 20 (that is, the first magnetic flux path C1 passing through the first movable core 31 and the stationary core 20), so that the amount of the magnetic flux in the second magnetic flux path C2 (bypass path), which passes through the second movable core 41 and the stationary core 20, is increased. As a result, the magnetic attraction of the second movable core 41 to the stationary core 20 is properly generated.

Further, in the state shown in (c) of FIG. 4, the non-magnetic portion 25 is interposed between the stationary core 20 and the second movable core 41, which are radially opposed to each other. The non-magnetic portion 25 functions as a magnetic flux restricting portion that restricts the flow of the magnetic flux that passes through in the radial direction between the stationary core 20 and the second movable core 41. As a result, an appropriate axial magnetic attractive force can be generated between the stationary core 20 and the second movable core 41.

As shown in (a) of FIG. 4, the amount of movement of the first movable core 31 at the time of magnetically attracting the first movable core 31 toward the stationary core 20 in response to the generation of the drive magnetic flux is A1. Furthermore, as shown in (b) of FIG. 4, after the movement of the first movable core 31, the amount of movement of the second movable core 41 at the time of magnetically attracting the second movable core 41 alone toward the stationary core 20 after the movement of the first movable core 31 is A2. The amount of movement A1 and the amount of movement A2 have a relationship of A1 < A2. In this case, since the amount of movement A1 of the first movable core 31 at the initial stage of energization is relatively small, responsiveness of the movement of the first movable core 31 at the initial stage of energization is improved. Furthermore, since the amount of movement A2 of the second movable core 41 alone is relatively large, the maximum opening degree of the valve element 42 can be increased while taking into account that the movement of the first movable core 31 imparts an inertial force to the second movable core 41.

Next, the operation at the valve closing time of the fuel injection valve 10 will be explained with reference to (a) to (c) of FIG. 5. In (a) of FIG. 5, the drive magnetic flux flows through the magnetic flux paths C1, C2, so that the first movable core 31 and the second movable core 41 are held in a state where the first movable core 31 and the second movable core 41 are attracted to the stationary core 20, and the valve element 42 is held at the second lift position, which is a position of the maximum opening degree. At the end of the fuel injection, as shown in (b) of FIG. 5, by switching from the state in which the magnetic flux flows through the magnetic flux paths C1 and C2 to the state in which the magnetic flux flows only through the first magnetic flux path C1, the valve element 42 is returned from the second lift position to the first lift position, which is an intermediate position. At this time, as the energization current of the solenoid coil 51 is reduced, the magnetic flux in the second magnetic flux path C2 is interrupted. Thus, the second movable core 41 and the valve element 42 are returned from the second lift position to the first lift position by an urging force of the spring 45. The valve element 42 is then temporarily stopped at the first lift position.

Here, in the fuel injection valve 10, the first movable core 31 is disposed inside the solenoid coil 51, and the second movable core 41 is disposed inside the first movable core 31. Therefore, when the energization current of the solenoid coil 51 is reduced in the state where the first movable core 31 and the second movable core 41 are attracted to the stationary core 20, the magnetic flux is weakened in the second magnetic flux path C2 located on the side farther from the solenoid coil 51 among the magnetic flux paths C1, C2, so that only the second movable core 41 is separated from the stationary core 20.

In addition, on the side of the second movable core 41, which is opposite to the valve element 42, the contact portion 37 of the first movable core 31 is provided, and the through hole 36 is provided in the contact portion 37. The through hole 36 serves as a flow restricting passage. In the state where the valve element 42 is lifted to the second lift position, a rear space S is formed on the back side of the second movable core 41, i.e., the rear space S is formed between the second movable core 41 and the contact portion 37 of the first movable core 31. When the valve element 42 is returned from the second lift position to the first lift position, this rear space S functions as a damper chamber, mitigating the impact upon contact between the second movable core 41 and the contact portion 37. That is, in the first movable core 31, the portion forming the rear space S (the contact portion 37, through hole 36, etc.) serves as a cushioning portion that mitigates the impact when the second movable core 41 contacts the contact portion 37 as the valve element 42 is returned from the second lift position to the first lift position.

As a result, at the valve closing time of the fuel injection valve 10, the impact generated as the second movable core 41, which is separated from the stationary core 20, abuts against the contact portion 37 of the first movable core 31 is reduced. Therefore, it is possible to suppress an unintended separation of the first movable core 31 from the stationary core 20 caused by the impact at the time of abutting the second movable core 41 against the contact portion 37 of the first movable core 31.

Then, as shown in (c) of FIG. 5, when the energization of the solenoid coil 51 is stopped, the drive magnetic flux disappears (i.e., the generation of the drive magnetic flux stops), and the valve element 42 is returned to the valve closing position by the urging force of the spring 45. As a result, the fuel injection is stopped. In this case, the valve element 42 does not move all at once from the maximum opening degree (i.e., the second lift position) to the valve closing position, but instead temporarily stops at the intermediate position (i.e., the first lift position) before returning to the valve closing position. Therefore, the valve closing speed of the valve element 42 is reduced, and the impact at the time of abutting the valve element 42 against a seat surface around the injection hole is reduced. Accordingly, wear of the valve element 42 is suppressed.

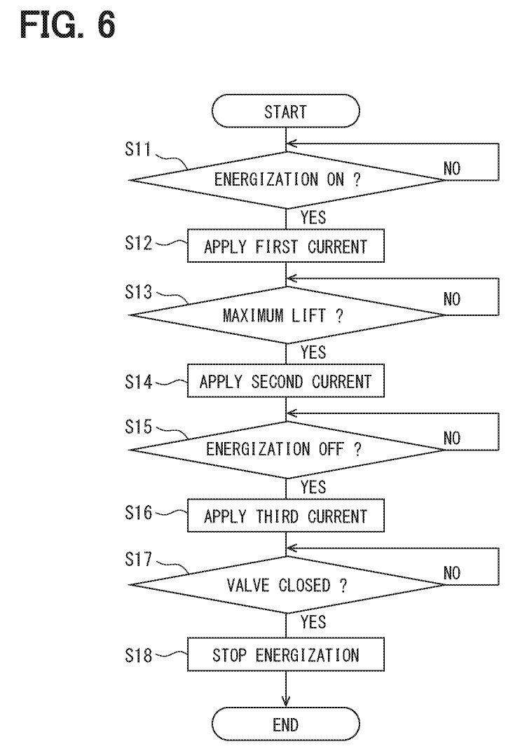

At the valve opening time and the valve closing time of the fuel injection valve 10, energization control of the solenoid coil 51 is performed by the controller 54, and the energization control will be described below. FIG. 6 is a flowchart showing a process procedure for the energization control of the solenoid coil 51. This process is executed by the controller 54 each time fuel injection by the fuel injection valve 10 is performed in the gas engine. In the energization control, the current applied from the drive circuit 53 to the solenoid coil 51 is controlled by the controller 54.

In FIG. 6, in step S11, it is determined whether it is the timing at which the energization signal is turned on. Here, if it is determined that it is the timing at which the energization signal is turned on, the process proceeds to step S12. In step S12, a first current I1 is applied to the solenoid coil 51. The first current I1 is a valve-opening current that is applied to lift the valve element 42 to the second lift position. By application of this current, the drive magnetic flux is generated. Thereby, the valve element 42 is lifted from the valve closing position to the first lift position by the attraction of the first movable core 31 to the stationary core 20, and subsequently, the valve element 42 is lifted from the first lift position to the second lift position by the attraction of the second movable core 41 to the stationary core 20.

Thereafter, in step S13, it is determined whether the valve element 42 has reached the maximum opening degree (i.e., the second lift position). At this time, it is preferable to determine that the valve element 42 has reached the maximum opening degree upon lapse of a predetermined time period from the start of the energization of the solenoid coil 51. If step S13 is affirmative (YES), the process proceeds to step S14. In step S14, a second current I2 is applied to the solenoid coil 51. The second current I2 is smaller than the first current I1 (the valve-opening current) and serves as a current that generates a magnetic flux, as the drive magnetic flux, to hold the valve element 42 at the second lift position. The second current I2 corresponds to a holding current for holding the valve element 42 at the second lift position. Steps S11 to S14 serve as a process of a first control.

Thereafter, in step S15, it is determined whether it is the timing at which the energization signal is turned off. Here, if it is determined that it is the timing at which the energization signal is turned off, the process proceeds to step S16. In step S16, a third current I3 is applied to the solenoid coil 51. The third current I3 is a current that is smaller than the first current I1 and the second current I2. The third current I3 has a current level that causes separation of only the second movable core 41 among the first movable core 31 and the second movable core 41 from the stationary core 20, in the attracted state where the first movable core 31 and the second movable core 41 are attracted to the stationary core 20. The third current I3 is preferably predetermined by calibration or the like.

Thereafter, in step S17, it is determined whether to close the valve element 42. At this time, it is preferable that, upon lapse of a predetermined time period TA from the start of applying the third current I3, it is determined to close the valve element 42. If step S17 is affirmative (YES), the process proceeds to step S18. In step S18, the energization of the solenoid coil 51 is stopped. Steps S15 to S18 serve as a process of a second control.

Incidentally, if the pressure of the gas fuel introduced into the fuel passage 12 is high, movement of the valve element 42 in the valve opening state toward the valve closing side may be delayed. In this case, at the end of the fuel injection, from the state in which the first movable core 31 and second movable core 41 are attracted to the stationary core 20, the time period required to separate only the second movable core 41 from the stationary core 20 and return the valve element 42 to the first lift position may be prolonged.

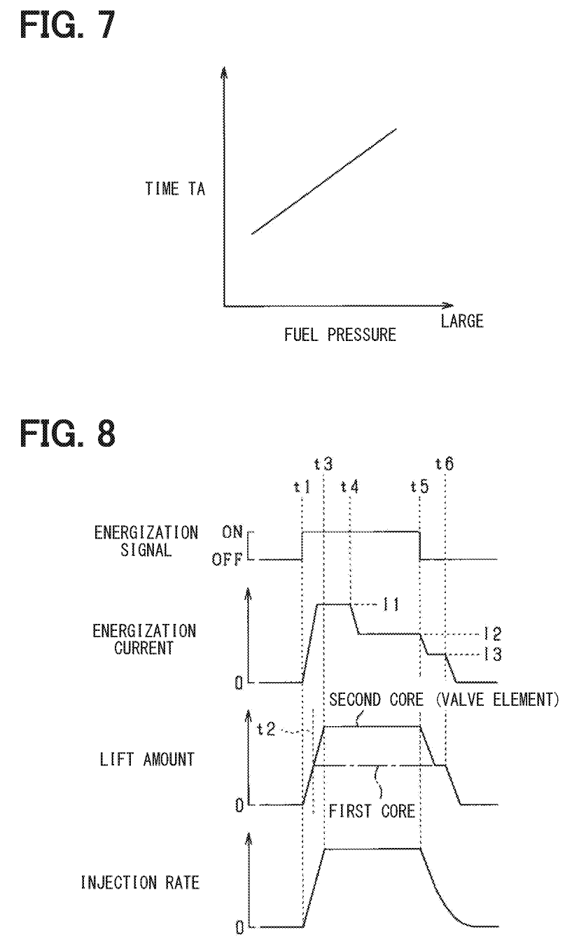

In view of this, in step S17, it is preferable to variably set, based on the pressure of the gas fuel, the time period TA for applying the third current I3 after output of a turn-off command for turning off the energization. Specifically, the time period TA may be set based on the pressure of the gas fuel using the relationship of FIG. 7. According to FIG. 7, the higher the pressure of the gas fuel, the longer the time period set as the time period TA.

FIG. 8 is a time chart showing changes in the lift amount of each of the movable cores 31, 41, changes in the energization current, and changes in the injection rate during opening and closing of the fuel injection valve 10. Note that the lift amount of the second movable core 41 corresponds to the lift amount of the valve element 42. The energization signal is an injection-valve control signal (serving as an energization command) outputted from the controller 54. When the energization signal is turned on, the solenoid coil 51 is energized. When the energization signal is turned off, the energization of the solenoid coil 51 is stopped. The injection rate is the amount of the fuel injection per unit time. In FIG. 8, as the lift amounts of the movable cores 31, 41, the lift amount of the first movable core 31 is shown by a dot-dash line, and the lift amount of the second movable core 41 is shown by a solid line.

In FIG. 8, at timing t1, energization of the solenoid coil 51 is started by turning on the energization signal, and the first current I1 is applied to the solenoid coil 51. In response to the start of the energization, the first movable core 31 and the second movable core 41 begin to move, lifting the valve element 42 toward the valve opening side. At the initial stage of the energization, since the first movable core 31 and the second movable core 41 move integrally, the lift amounts of the movable cores 31, 41 coincide with each other. As the lift amount of the valve element 42 increases, the injection rate gradually increases.

Thereafter, at timing t2, the first movable core 31 abuts against the stationary core 20, so that the first movable core 31 stops at the first lift position. After the timing t2, the second movable core 41 is lifted alone, and the lift amount of the valve element 42 increases.

Then, at timing t3, the second movable core 41 contacts the stationary core 20, whereby the valve element 42 stops at the second lift position (the maximum opening degree). During the time period from the timing t1 to the timing t3, the movements of the movable cores 31 and 41 cause the valve element 42 to perform a two-stage lift operation, thereby enabling an increase in the maximum opening degree of the injection hole 14a and an increase in the injection rate.

Thereafter, at timing t4, the energization current of the solenoid coil 51 is switched from the first current I1 for shifting the valve element 42 to the valve opening state to the second current I2 for holding the valve element 42 in the valve opening state. Even after the timing t4, the valve element 42 is held at the second lift position (the maximum opening degree).

Thereafter, at timing t5, the energization signal is turned off, and the energization current of the solenoid coil 51 is switched to the third current I3. As a result, the second movable core 41 and the valve element 42 are returned by the urging force of the spring 45 to the first lift position (the intermediate position) and are temporarily stopped at the first lift position. In this case, since prior to timing t5, which is the turn-off timing of the energization signal, the energization current has been reduced from the first current I1 to the second current I2, the energization current of the solenoid coil 51 can be switched promptly to the current level (the third current I3) that temporarily stops the valve element 42 at the first lift position.

Here, when the second movable core 41 separated from the stationary core 20 is returned to the first lift position, the second movable core 41 abuts against the contact portion 37 of the first movable core 31. If the impact at that time is large, the first movable core 31 may move away from the stationary core 20, and there is a concern that temporary stopping of the second movable core 41 at the first lift position will become impossible. Therefore, at the timing t5, it is preferable that the energization control of the solenoid coil 51 be performed such that, when the second movable core 41 abuts against the contact portion 37 of the first movable core 31, the first movable core 31 is not separated from the stationary core 20.

That is, the third current I3 for returning the second movable core 41 to the intermediate position (first lift position) preferably produces a magnetic attractive force that absorbs the kinetic energy at the time when the second movable core 41 abuts against the contact portion 37 of the first movable core 31 by the urging force of the spring 45 and limits the separation of the first movable core 31 from the stationary core 20 caused by the kinetic energy. Furthermore, when switching the energization current of the solenoid coil 51 from the second current I2 to the third current I3, the current command value may be switched so as to change gradually rather than being switched all at once.

Thereafter, at timing t6, the energization of the solenoid coil 51 is stopped. As a result, the valve element 42 is returned to the valve closing position by the urging force of the spring 45, and the fuel injection is stopped.

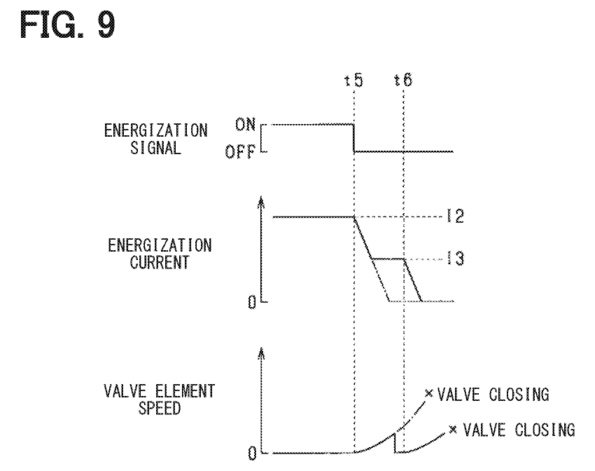

FIG. 9 is a time chart showing the valve element speed at the valve closing time of the valve element 42. In FIG. 9, the solid line shows changes in the energization current and changes in the valve element speed in the present embodiment, and the dot-dash line shows, as a comparative example, changes in the energization current and changes in the valve element speed when the energization current is cut off all at once from the second current I2.

In the comparative example, when the energization signal is turned off at the timing t5, the energization is immediately cut off, and the valve element 42 moves all at once to the valve closing position by the urging force of the spring 45. In this case, the valve element speed at the time when the valve element 42 reaches the valve closing position becomes high, and there is a concern that the valve element 42 will wear due to the impact when the valve element 42 abuts against the seat surface around the injection hole 14a.

In contrast, in the present embodiment, when the energization signal is turned off at the timing t5, the energization current is once reduced to the third current I3, and then the energization is cut off at the timing t6. In this case, since the valve element 42 moves to the valve closing position after once stopping at the intermediate position (the first lift position), the valve element speed changes in the order of increase, decrease, and increase, and the valve element speed at the time when the valve element 42 reaches the valve closing position becomes relatively low. Therefore, wear of the valve element 42 due to the impact at the time when the valve element 42 abuts against the seat surface around the injection hole 14a is suppressed.

The embodiment described above can achieve the following advantages.

In the fuel injection valve 10, by the attraction of the first movable core 31 to the stationary core 20 at the fuel injection time, the valve element 42 is lifted from the valve closing position to the first lift position, and subsequently, by the attraction of the second movable core 41 to the stationary core 20, the valve element 42 is lifted to the second lift position. Thus, the two-stage lift of the valve element 42 is performed, enabling the high flow rate of the gas fuel.

Further, at the end of the fuel injection, the valve element 42 is returned from the second lift position to the first lift position, and temporarily stops at the first lift position, and is then returned to the valve closing position by the urging force of the spring 45. In this case, the valve element 42 does not move all at once from the maximum opening degree (i.e., the second lift position) to the valve closing position, but instead temporarily stops at the intermediate position (i.e., the first lift position) before returning to the valve closing position. Therefore, the impact at the time when the valve element 42 abuts against the seat surface is reduced, and wear of the valve element 42 is suppressed. As a result, it is possible to achieve protection of the valve element 42 while achieving the high flow rate of the gas fuel.

The second movable core 41 is received in the movable state within the hollow portion of the first movable core 31, and the solenoid coil 51 is provided so as to surround the first movable core 31 and the stationary core 20. In this case, since the first movable core 31 is disposed inside the solenoid coil 51 and the second movable core 41 is further disposed inside the first movable core 31, at the end of the fuel injection, it becomes easy to separate only the second movable core 41 from the stationary core 20 from the state in which the first movable core 31 and the second movable core 41 are attracted to the stationary core 20. Thus, temporary stopping of the valve element 42 at the first lift position can be advantageously realized.

Upon generation of the drive magnetic flux in response to the energization of the solenoid coil 51, the first magnetic flux path, which passes through the first movable core 31 and the stationary core 20, is brought into magnetic saturation, and thereby the amount of the magnetic flux in the second magnetic flux path (bypass path), which passes through the second movable core 41 and the stationary core 20, is increased. As a result, at the initial stage of energization of the solenoid coil 51, the attraction of the first movable core 31, i.e., the movement of the first movable core 31 is performed with good responsiveness, and subsequently, the attraction of the second movable core 41, i.e., increase in the lift amount of the valve element 42 is appropriately performed.

The amount of movement (A1) of the first movable core 31 at the time when the first movable core 31 is attracted to the stationary core 20 in response to the generation of the drive magnetic flux is made smaller than the amount of movement (A2) of the second movable core 41 at the time when, after movement of the first movable core 31, the second movable core 41 alone is attracted to the stationary core 20. In this case, at the initial stage of energization of the solenoid coil 51, responsiveness of the movement of the first movable core 31 is enhanced, and, thereafter, at the valve opening time of the valve element 42, the appropriate valve opening operation can be performed by using the inertial force imparted by the operation of the first movable core 31.

In the fuel injection valve 10, on the side of the second movable core 41 opposite to the valve element 42, the cushioning portion is provided to mitigate the impact when the second movable core 41 abuts against the contact portion 37 of the first movable core 31 at the time of returning the valve element 42 from the second lift position to the first lift position. As a result, at the valve closing time of the fuel injection valve 10, the impact generated as the second movable core 41, which is separated from the stationary core 20, abuts against the contact portion 37 of the first movable core 31 is reduced. Therefore, inconvenience that the first movable core 31 is unintentionally separated from the stationary core 20 due to the impact when the second movable core 41 abuts against the contact portion 37 of the first movable core 31 is suppressed, and temporary stopping of the second movable core 41 at the first lift position can be appropriately performed.

At the valve closing time of the fuel injection valve 10, the energization control of the solenoid coil 51 is performed such that starting from the state where the first movable core 31 and the second movable core 41 are attracted to the stationary core 20, the second movable core 41 is separated from the stationary core 20 to temporarily stop the valve element 42 at the first lift position. In this case, the energization of the solenoid coil 51 is not stopped immediately upon the output of the turn-off command. Instead, the energization control of the solenoid coil 51 is performed in the two stages after the output of the turn-off command so as to temporarily stop the valve element 42 at the first lift position. Thus, the valve element speed at the valve closing time can be appropriately adjusted.

After the start of the energization of the solenoid coil 51, the energization control is performed such that the valve-opening current for lifting the valve element 42 to the second lift position is supplied to the solenoid coil 51, and thereafter the holding current, which is lower than the valve-opening current and is for holding the valve element 42 at the second lift position, is supplied to the solenoid coil 51. Thus, after opening of the fuel injection valve 10, the energization current (the drive magnetic flux) of the solenoid coil 51 need only be the minimum current required to maintain the valve-open state of the valve element 42. Thereafter, when closing the fuel injection valve 10, the current can be promptly transitioned to the current level that temporarily stops the valve element 42 at the first lift position.

At the valve closing time of the fuel injection valve 10, when the second movable core 41, which is separated from the stationary core 20, abuts against the contact portion 37 of the first movable core 31, the first movable core 31 may possibly be separated from the stationary core 20 due to the impact. If the first movable core 31 is separated from the stationary core 20, the second movable core 41 can no longer be temporarily stopped at the first lift position. In this regard, the first movable core 31 is prevented from separating from the stationary core 20 by the energization control of the solenoid coil 51. As a result, the speed adjustment at the valve closing time of the valve element 42 can be appropriately performed.

If the pressure of the gas fuel introduced into the fuel passage 12, i.e., the pressure on the rear side of the distal end valve portion 44 of the valve element 42 is high, it is conceivable that, with the valve element 42 in the valve opening state, movement of the valve element 42 toward the valve closing side is delayed. In this case, at the end of the fuel injection, from the state in which the first movable core 31 and second movable core 41 are attracted to the stationary core 20, the time period required to separate only the second movable core 41 from the stationary core 20 and return the valve element 42 to the first lift position may be prolonged. In this regard, since the time for applying the third current after the output of the turn-off command is variably set based on the pressure of the gas fuel, even if the fuel pressure changes, the valve element 42 can be appropriately returned to the first lift position at the end of the fuel injection.

### Second Embodiment

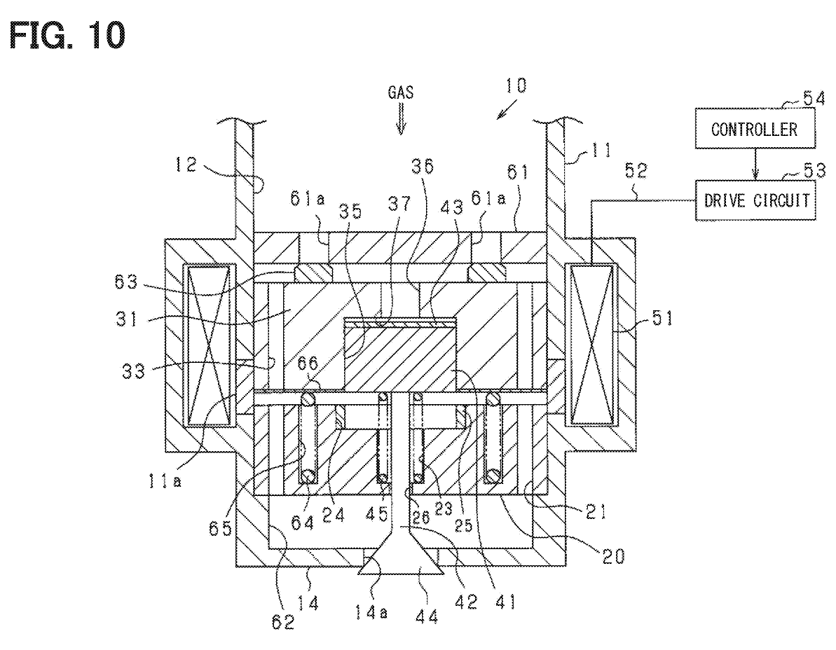

The fuel injection valve 10 may be configured as shown in FIG. 10. Here, for the fuel injection valve 10 of FIG. 10, differences from the configuration of FIG. 1 are described.

In the fuel injection valve 10 of FIG. 10, as a difference from the injection-valve structure shown in FIG. 1, a partition wall 61 is provided in the housing 11 to partition the fuel passage 12 into an upstream side and a downstream side, and a fuel chamber 62 is defined between the partition wall 61 and the end plate portion 14 in the housing 11. A plurality of communication holes 61a are formed through the partition wall 61 to communicate between the upstream side and the downstream side of the partition wall 61. The communication holes 61a are arranged in the circumferential direction at the partition wall 61. The partition wall 61 serves as a partition. Furthermore, each of the communication holes 61a serves as an upstream-side opening, and the injection hole 14a serves as a downstream-side opening.

The stationary core 20, the first movable core 31, and the second movable core 41 are disposed inside the fuel chamber 62. A seal member 63, which serves as an upstream-side valve element for opening and closing the communication holes 61a of the partition wall 61, is fixed to the first movable core 31. The seal member 63 is formed in a circular ring shape and is attached to an upstream-side end surface of the first movable core 31 at a location that is opposed to the communication holes 61a. The seal member 63 is made of any of elastic materials having elasticity, such as a rubber material, a resin material, or an elastomer material. More specifically, it is preferable to use, as a seal material of the seal member 63, fluoro rubber or EPDM (ethylene propylene diene monomer) rubber.

A spring 64 made of a compression coil spring is disposed between the first movable core 31 and the stationary core 20. The first movable core 31 is urged by the spring 64 toward the valve closing side in which the seal member 63 closes the communication holes 61a. A spring receiving portion 65, which is formed in a circular ring groove shape, is formed in the stationary core 20, and the spring 64 is provided in a state where the spring 64 is received in the spring receiving portion 65. Thereby, the first movable core 31 is held in a state where the first movable core 31 is separated from the stationary core 20, that is, in a state where an air gap is formed between the first movable core 31 and the stationary core 20.

With respect to the second movable core 41 and the valve element 42, the configuration is the same as that of FIG. 1. The valve element 42 serves as a downstream-side valve element. The spring 64 serves as a first spring, and the spring 45 serves as a second spring.

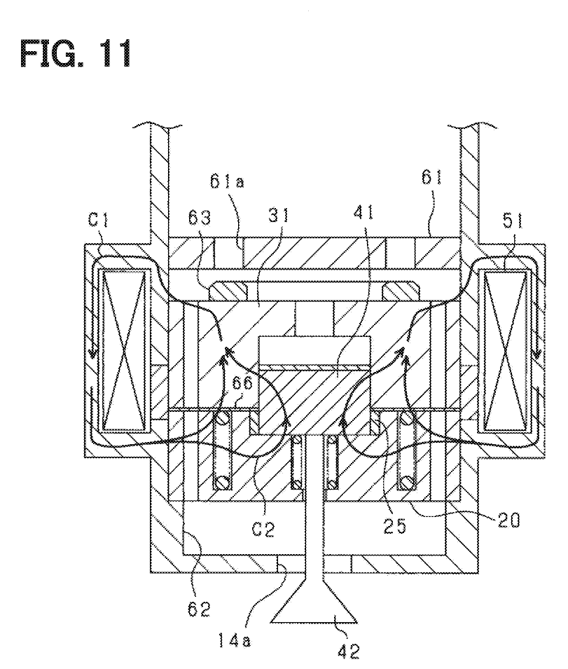

In the fuel injection valve 10 of FIG. 10, at the start of the fuel injection, the energization of the solenoid coil 51 is started in response to turning on of the energization signal. Thereby, movement of the first movable core 31 and the second movable core 41 starts, and both the communication holes 61a and the injection hole 14a are opened. At this time, as in the previously described embodiment, the movement of the first movable core 31 and the second movable core 41 in response to the generation of the drive magnetic flux causes the valve element 42 to lift continuously in two stages, i.e., to the first lift position and then to the second lift position. A valve opening state of the fuel injection valve 10 is shown in FIG. 11. In FIG. 11, the drive magnetic flux flows through the magnetic flux paths C1, C2, so that the first movable core 31 and the second movable core 41 are attracted to the stationary core 20.

Further, at the end of the fuel injection, as in the previously described embodiment, after the energization signal is turned off, starting from the state where the first movable core 31 and the second movable core 41 are attracted to the stationary core 20, the second movable core 41 and valve element 42 are returned from the second lift position to the first lift position and are temporarily stopped in the first lift position. Thereafter, the second movable core 41 and the valve element 42 are returned to the valve closing position by the urging force of the spring 45.

Meanwhile, as described above, temporarily stopping the valve element 42 at the first lift position (the intermediate position) after turning off the energization signal at the end of the fuel injection reduces the valve closing speed when the valve element 42 seats on the seat surface, thereby suppressing wear of the valve element, but may worsen the injection cut-off at the end of injection. On the other hand, in the fuel injection valve 10 of FIG. 10, at the end of injection, it is possible to improve the injection cut-off by changing the energization mode of the solenoid coil 51.

Specifically, when the energization signal is turned off, the energization of the solenoid coil 51 is stopped to eliminate the drive magnetic flux. Therefore, starting from the state where the first movable core 31 and second movable core 41 are attracted to the stationary core 20, the first movable core 31 is separated from the stationary core 20 to close the communication holes 61a of the partition wall 61 with the seal member 63. Thereafter, the second movable core 41 is moved to the valve closing position, and the injection hole 14a is closed by the valve element 42 at a timing delayed from the closing of the communication holes 61a. In this case, among the upstream-side communication holes (the upstream-side openings) 61a and the downstream-side injection hole (the downstream-side opening) 14a, the communication holes 61a are closed first. This quickly stops the fuel supply from the upstream side after stopping the energization of the solenoid coil 51, and thereby the pressure drop in the fuel chamber 62 is accelerated. As a result, the injection cut-off at the end of energization of the fuel injection valve 10 is improved.

Here, in the fuel injection valve 10, in a state where the upstream-side openings (the communication holes 61a) are opened, the gas fuel flows into the rear space on the side of the second movable core 41 opposite to the valve element 42. In this case, when the upstream-side openings (the communication holes 61a) are closed in response to the end of the fuel injection, it is preferable that the rear space of the second movable core 41 becomes a closed space that is closed by the first movable core 31 and the seal member 63. In this way, after the upstream-side openings (the communication holes 61a) are closed, returning of the second movable core 41 to the valve closing side is prevented by the gas fuel remaining in the closed space (the rear space). Therefore, after the energization of the solenoid coil 51 is stopped, the outflow of the fuel from the fuel chamber 62 through the injection hole 14a can be quickly performed, and, consequently, the injection cut-off performance at the end of the fuel injection can be improved.

Furthermore, in the valve opening state of the fuel injection valve 10, it is preferable that the separation distance between the first movable core 31 and the stationary core 20 is greater than the separation distance between the second movable core 41 and the stationary core 20. Specifically, it is preferable that a spacer 66, which is formed in a plate shape and is made of a non-magnetic material, is interposed between the surface of the first movable core 31 and the surface of the stationary core 20, which are opposed to each other. The spacer 66 is preferably provided on at least one of the opposed surfaces of the first movable core 31 and the stationary core 20. In this case, at the time of disappearance of the drive magnetic flux, the first movable core 31 becomes easier to separate from the stationary core 20 than the second movable core 41. Therefore, the configuration, in which the communication holes 61a are closed earlier among the communication holes 61a and the injection hole 14a, is suitably realized.

In the present embodiment, as the energization control at the valve closing time of the fuel injection valve 10, the valve-closing speed reduction control, which reduces the valve closing speed of the valve element 42, and the injection cut-off improvement control, which improves the injection cut-off, are selectively carried out. The valve-closing speed reduction control is implemented at the end of the fuel injection after the output of the turn-off command for turning off the energization signal. That is, starting from the state where the first movable core 31 and second movable core 41 are attracted to the stationary core 20, the second movable core 41 and the valve element 42 are returned from the second lift position to the first lift position and are temporarily stopped in the first lift position. Thereafter, the second movable core 41 and the valve element 42 are returned to the valve closing position by the urging force of the spring 45. The injection cut-off improvement control is implemented at the end of the fuel injection after the output of the turn-off command for turning off the energization signal. That is, starting from the state where the first movable core 31 and the second movable core 41 are attracted to the stationary core 20 (the state where the communication holes 61a, which serve as the upstream-side openings, and the injection hole 14a, which serves as the downstream-side opening, are opened), the communication holes 61a are closed first by the seal member 63 upon the energization stop. Thereafter, the injection hole 14a is closed by the valve element 42.

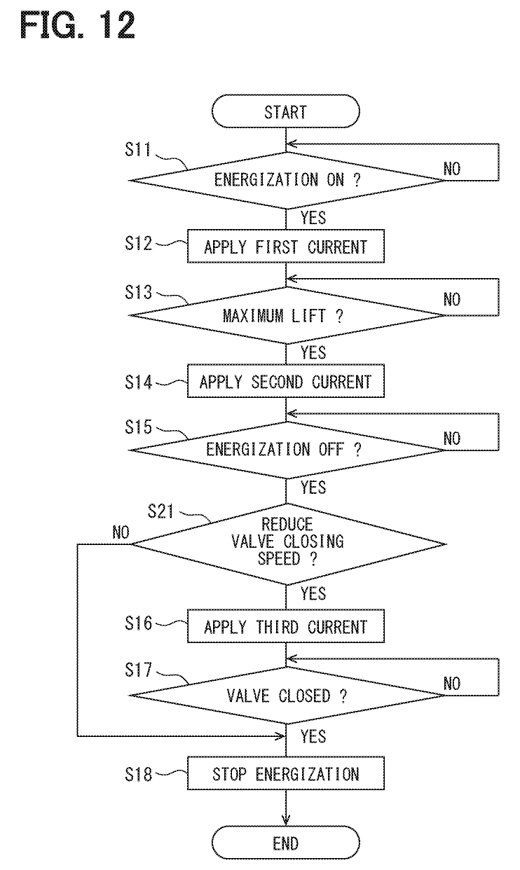

FIG. 12 is a flowchart showing the energization control process of the solenoid coil 51 according to the present embodiment. The process of FIG. 12 is executed by the controller 54 in place of the process of FIG. 6. In FIG. 12, the same step numbers are assigned to the same steps as in FIG. 6, and descriptions thereof are omitted.

In FIG. 12, at the time of starting the fuel injection, after the energization of the solenoid coil 51 is started in response to the turning on of the energization signal, the energization current is switched to the first current I1 and then to the second current I2, and in this energization state, the valve element 42 is held at the second lift position (steps S11 to S14). Then, in step S15, when it is determined that it is the timing at which the energization signal is turned off, the process proceeds to step S21.

In step S21, it is determined whether to perform the valve-closing speed reduction control that reduces the valve closing speed of the valve element 42. This determines the condition for selecting between the valve-closing speed reduction control and the injection cut-off improvement control. For example, it determines whether wear suppression of the valve element 42 of the fuel injection valve 10 is required under the circumstances. If the wear suppression of the valve element 42 of the fuel injection valve 10 is required, step S21 is affirmed (YES), and the process proceeds to step S16 to execute the valve-closing speed reduction control. In step S21, it is preferable that whether to perform wear suppression is determined based on the wear state of valve element 42. Specifically, it is preferable that whether to perform the wear suppression is determined based on the usage history of the fuel injection valve 10, such as the injection count, combustion cycle count of the gas engine, a service period or mileage of the vehicle on which the gas engine is mounted, etc. In this case, for example, if the injection count of fuel injection valve 10 is a predetermined number or more, or the combustion cycle count of the gas engine is a predetermined number or more, etc., it is preferable to deem this a situation where deterioration of the valve element 42 may occur and determine to execute the wear suppression.

Note that, compared to the valve-closing speed reduction control, the injection cut-off improvement control is considered to yield a better fuel consumption rate. Therefore, the injection cut-off improvement control may be executed on condition that the fuel economy improvement is prioritized for the gas engine, such as when the driving mode is the economy mode, etc.

Then, in steps S16 to S18, the valve-closing speed reduction control is carried out. At this time, the third current I3, which is smaller than the first current I1 and the second current I2, is applied to the solenoid coil 51, and the energization of the solenoid coil 51 is stopped upon lapse of a predetermined time period TA from the start of the application of the third current I3, thereby closing the valve element 42.

In step S21, when it is determined that it is not a situation for executing the valve-closing speed reduction control, steps S16 and S17 are skipped, and the process proceeds to step S18. In this case, the energization of the solenoid coil 51 is stopped immediately based on the turn-off command for turning off the energization signal.

Likewise, in the fuel injection valve 10 of the present embodiment, the two-stage lift of the valve element 42 by the first movable core 31 and the second movable core 41 allows for the high flow rate of the gas fuel. Furthermore, at the time of closing the valve element 42 at the end of the fuel injection, instead of returning the valve element 42 all at once to the valve closing position, the valve element 42 is temporarily stopped at the first lift position (the intermediate position) and is thereafter returned to the valve closing position, thereby reducing the impact when the valve element 42 abuts against the seat surface and suppressing wear of the valve element 42. As a result, it is possible to achieve protection of the valve element 42 while achieving the high flow rate of the gas fuel.

Furthermore, the valve-closing speed reduction control, which reduces the valve closing speed of the valve element 42, and the injection cut-off improvement control, which improves the injection cut-off, are selectively carried out. Thus, in the fuel injection valve 10, the energization control of the solenoid coil 51 can be appropriately executed while judging which of the wear suppression of the valve element 42 or the injection cut-off improvement to prioritize.

### Other Embodiments

The above embodiments may be modified, for example, as follows.

In each embodiment described above, the amount of movement A1 of the first movable core 31 at the time of magnetically attracting the first movable core 31 toward the stationary core 20 in response to the generation of the drive magnetic flux, and the amount of movement A2 of the second movable core 41 at the time of magnetically attracting the second movable core 41 alone toward the stationary core 20 after the movement of the first movable core 31 are set to have the relationship of A1 < A2. This relationship may be changed. The relationship between the amount of movement A1 and the amount of movement A2 may be set to A1 = A2 or A1 > A2.

In each embodiment described above, the first movable core 31 is formed in the bottomed tubular shape and has the hollow portion inside the first movable core 31, and the circular ring portion and the contact portion 37 are made of the magnetic material. However, this may be changed such that a contact plate, which serves as a contact portion and is made of a non-magnetic material, is provided at an axial end portion of the circular ring portion of the first movable core 31.

In the solenoid energization control process of FIG. 6, it is also possible to omit the processes of steps S13 and S14. In this case, after the energization signal is turned on and the energization of the solenoid coil 51 is started, the energization current remains the first current I1, and under that energization state, the valve element 42 is held at the second lift position. The same applies to the solenoid energization control process of FIG. 12.

In the above first embodiment, it is possible to adapt a configuration that switches between: a state executing the valve-closing speed reduction control by temporarily stopping the second movable core 41 at the first lift position at the end of the fuel injection to reduce the closing speed of the valve element 42; and a state not executing that control. Specifically, in the fuel injection system using the fuel injection valve 10 shown in FIG. 1, the solenoid energization control process of FIG. 12 is executed. In this case, in step S21 of FIG. 12, it is determined whether to perform the valve-closing speed reduction control, and if affirmed (YES), the valve-closing speed reduction control is performed, and if negated (NO), the valve-closing speed reduction control is not performed. As a result, the configuration in which the valve-closing speed reduction control is performed as needed can be realized.

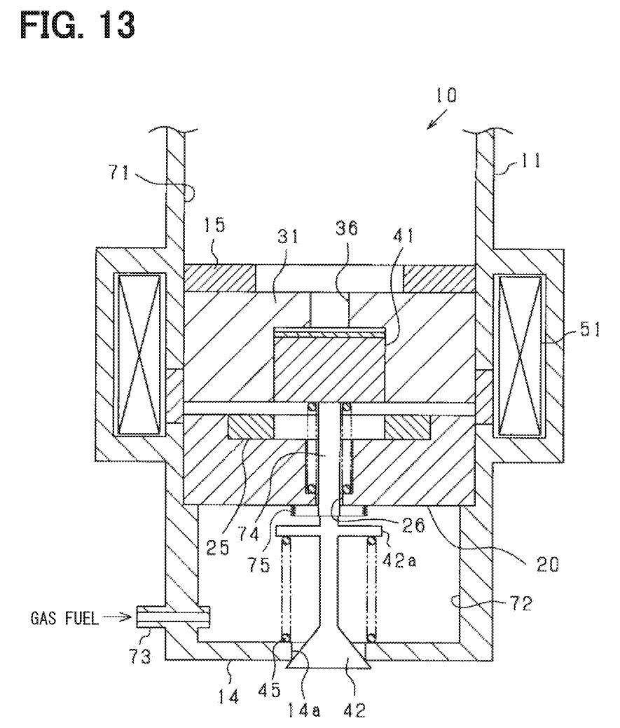

In each embodiment described above, the valve element 42 of the fuel injection valve 10 is a direct-acting outward-opening valve that operates in response to the energization of the solenoid coil 51. However, this may be changed such that the valve element 42 is a balancing valve that operates according to pressure balance. Specifically, it is conceivable to configure the fuel injection valve 10 as shown in FIG. 13.

In the fuel injection valve 10 of FIG. 13, as a difference from FIG. 1 described above, an upper side of the first movable core 31 is an atmosphere chamber 71 opened to the atmosphere, and a distal end side of the housing 11 is a fuel chamber 72 into which the gas fuel is introduced. A predetermined pressure of the gas fuel is introduced into the fuel chamber 72 through an inlet passage 73. A connecting rod 74 is fixed at a lower end surface of the second movable core 41 in the drawing. The valve element 42 of the outward-opening valve type is disposed at a distal end of the connecting rod 74 in a state where the valve element 42 is continuous with the connecting rod 74 in the axial direction. A bellows 75 is provided between the connecting rod 74 and the valve element 42. The bellows 75 is extensible and contractible and isolates the fuel chamber 72 from the atmosphere. The valve element 42 has a spring receiving portion 42a, which is formed in a flange shape, and the spring 45, which urges the valve element 42 toward the valve closing side, is disposed between the spring receiving portion 42a and the end plate portion 14. The valve element 42 is opened by the movement of the movable cores 31, 41 and the connecting rod 74 in response to the energization of the solenoid coil 51, and the valve element 42 is closed in accordance with balance among the urging force of the spring 45, the fuel pressure in the fuel chamber 72 and a cylinder pressure after the turning off of the energization of the solenoid coil 51. The second movable core 41 and the connecting rod 74 may be separable.

Technical aspects, which are obtained based on the embodiments described above, will be recited below.

### Configuration 1

According to configuration 1, there is provided a gas fuel injection valve (10) that is configured to inject a gas fuel, the gas fuel injection valve including:

a main body (11) that has:

a fuel passage (12) which is configured to conduct the gas fuel; and

an injection hole (14a) which is configured to inject the gas fuel received in the fuel passage;

a valve element (42) that is configured to open and close the injection hole;

a spring member (45) that is configured to urge the valve element in a valve closing direction;

a stationary core (20) that is fixed to the main body;

a first movable core (31) that is configured to be attracted to the stationary core at a time of fuel injection in response to generation of a drive magnetic flux and thereby lift the valve element from a valve closing position to a first lift position; and

a second movable core (41) that, subsequent to lifting of the valve element to the first lift position by the first movable core, is configured to be attracted to the stationary core by the drive magnetic flux to further lift the valve element from the first lift position to a second lift position at which a lift amount of the valve element is greater than at the first lift position, wherein:

the valve element is driven at an end of the fuel injection such that the valve element is returned from the second lift position to the first lift position, and is temporarily stopped at the first lift position, and is then returned to the valve closing position by an urging force of the spring member.

### Configuration 2

According to configuration 2, there is provided the gas fuel injection valve according to configuration 1, wherein:

the first movable core is formed in a tubular shape and has a hollow portion inside the first movable core, and the second movable core is received in the hollow portion in a state in which the second movable core is movable in the hollow portion; and

a solenoid coil (51), which is configured to generate the drive magnetic flux, is arranged to surround the first movable core and the stationary core.

### Configuration 3

According to configuration 3, there is provided the gas fuel injection valve according to configuration 1 or 2, wherein upon the generation of the drive magnetic flux, a first magnetic flux path, which passes through the first movable core and the stationary core, is brought into magnetic saturation, and thereby an amount of a magnetic flux of a second magnetic flux path, which passes through the second movable core and the stationary core, is increased.

### Configuration 4

According to configuration 4, there is provided the gas fuel injection valve according to any one of configurations 1 to 3, wherein an amount of movement of the first movable core, which is generated when the first movable core is attracted to the stationary core in response to the generation of the drive magnetic flux, is smaller than an amount of movement of the second movable core, which is generated when the second movable core is attracted to the stationary core after the movement of the first movable core.

### Configuration 5

According to configuration 5, there is provided the gas fuel injection valve according to any one of configurations 1 to 4, wherein:

the valve element is an outward-opening valve that is brought into a valve opening state when the valve element is moved toward an outside of the main body;

the first movable core has a contact portion (37) that is configured to contact the second movable core when the first movable core is moved together with the second movable core at a valve opening time of the valve element; and

a cushioning portion is provided on a side of the second movable core opposite to the valve element to mitigate impact generated by abutment of the second movable core against the contact portion of the first movable core when the valve element is returned from the second lift position to the first lift position at the end of the fuel injection.

### Configuration 6

According to configuration 6, there is provided a fuel injection system including:

the gas fuel injection valve according to any one of configurations 1 to 5; and

a controller (54) that includes a processor with a memory and is configured to control fuel injection by the gas fuel injection valve, wherein:

the gas fuel injection valve includes a solenoid coil (51) that is configured to generate the drive magnetic flux; and

the controller is configured, at the end of the fuel injection, to perform energization control of the solenoid coil as a first control such that, from a state in which the first movable core and the second movable core are attracted to the stationary core, only the second movable core among the first movable core and the second movable core is separated from the stationary core, and the valve element is temporarily stopped at the first lift position, and, as a second control following the first control, to stop energization of the solenoid coil in a state where the valve element is stopped at the first lift position.

### Configuration 7

According to configuration 7, there is provided the fuel injection system according to configuration 6, wherein after start of the energization of the solenoid coil, the controller is configured to perform energization control of the solenoid coil to supply a valve-opening current to the solenoid coil so that the first movable core and the second movable core are attracted to the stationary core, and thereby the valve element is lifted to the second lift position, and after the valve element is lifted to the second lift position, the controller is configured to perform energization control to supply a holding current, which is lower than the valve-opening current, to the solenoid coil so as to hold the valve element at the second lift position.

### Configuration 8

According to configuration 8, there is provided the fuel injection system according to configuration 6 or 7, wherein:

the first movable core has a contact portion (37) that is configured to contact the second movable core when the first movable core is moved together with the second movable core at a valve opening time of the valve element; and

as the first control, the controller is configured to perform the energization control of the solenoid coil so as to limit the first movable core from separating from the stationary core when the second movable core, which is separated from the stationary core, abuts against the contact portion of the first movable core.

### Configuration 9

According to configuration 9, there is provided the fuel injection system according to any one of configurations 6 to 8, wherein the controller is configured to variably set, based on a pressure of the gas fuel, a time period during which the first control is carried out.

### Configuration 10

According to configuration 10, there is provided the fuel injection system according to any one of configurations 6 to 9, wherein:

the main body includes a partition (61) that partitions the fuel passage into an upstream side and a downstream side, wherein an upstream-side opening (61a) is formed through the partition, and the injection hole serves as a downstream-side opening (14a);

the first movable core is integrated with an upstream-side valve element (63) configured to open and close the upstream-side opening and is urged toward a valve closing side by a first spring (64);

the second movable core is integrated with a downstream-side valve element (42) serving as the valve element and is urged toward a valve closing side by a second spring (45) serving as the spring member;

when the first movable core is attracted to the stationary core in response to the generation of the drive magnetic flux, the upstream-side valve element and the downstream-side valve element are both moved to the first lift position, and thereafter, the second movable core is attracted to the stationary core by the drive magnetic flux, thereby the downstream-side valve element is moved to the second lift position; and

the controller is configured to perform:

a valve-closing speed reduction control that, at the end of the fuel injection, from the state in which the first movable core and the second movable core are attracted to the stationary core, after temporarily stopping the second movable core at the first lift position, returns the first movable core and the second movable core to the valve closing position, thereby reducing a valve closing speed of the downstream-side valve element; and

an injection cut-off improvement control that, at the end of the fuel injection, from the state in which the first movable core and the second movable core are attracted to the stationary core, stops the generation of the drive magnetic flux and returns the upstream-side valve element to the valve closing position by the urging force of the first spring (64), and thereafter returns the downstream-side valve element to the valve closing position by the urging force of the second spring, thereby improving injection cut-off; and

the controller is configured to selectively perform the valve-closing speed reduction control and the injection cut-off improvement control.

Although the present disclosure has been described with reference to the embodiments and the modifications, it is understood that the present disclosure is not limited to the embodiments and the modifications and structures described therein. The present disclosure also encompasses various modifications and changes within the scope of equivalents. Also, various combinations and forms, as well as other combinations and forms that include only one element, more, or less, are within the scope and ideology of the present disclosure.

What is claimed is:

1. A gas fuel injection valve that is configured to inject a gas fuel, the gas fuel injection valve comprising:
a main body that has:
a fuel passage which is configured to conduct the gas fuel; and
an injection hole which is configured to inject the gas fuel received in the fuel passage;
a valve element that is configured to open and close the injection hole;
a spring member that is configured to urge the valve element in a valve closing direction;
a stationary core that is fixed to the main body;
a first movable core that is configured to be attracted to the stationary core at a time of fuel injection in response to generation of a drive magnetic flux and thereby lift the valve element from a valve closing position to a first lift position; and
a second movable core that, subsequent to lifting of the valve element to the first lift position by the first movable core, is configured to be attracted to the stationary core by the drive magnetic flux to further lift the valve element from the first lift position to a second lift position at which a lift amount of the valve element is greater than at the first lift position, wherein:
the first movable core is formed in a tubular shape and has a hollow portion inside the first movable core, and the second movable core is received in the hollow portion in a state in which the second movable core is movable in the hollow portion;
a solenoid coil, which is configured to generate the drive magnetic flux, is arranged to surround the first movable core and the stationary core;
the first movable core and the second movable core are opposed to the stationary core in a lift direction of the valve element;
a non-magnetic portion, which is formed in a circular ring shape and is made of a non-magnetic material, is disposed between the stationary core and the first movable core;
in a lift state of the valve element at the second lift position, the first movable core is attracted to the stationary core by a magnetic flux of a first magnetic flux path, which is located on a radially outer side of the non-magnetic portion and passes through the first movable core and the stationary core, and the second movable core is attracted to the stationary core by a magnetic flux of a second magnetic flux path, which is located on a radially inner side of the non-magnetic portion and passes through the second movable core and the stationary core; and
the valve element is driven at an end of the fuel injection such that the valve element is returned from the second lift position to the first lift position by conducting the magnetic flux only through the first magnetic flux path among the first magnetic flux path and the second magnetic flux path, and is temporarily stopped at the first lift position, and is then returned to the valve closing position by an urging force of the spring member.

2. The gas fuel injection valve according to claim 1, wherein upon the generation of the drive magnetic flux, the first magnetic flux path is brought into magnetic saturation, and thereby an amount of the magnetic flux of the second magnetic flux path is increased.

3. The gas fuel injection valve according to claim 1, wherein an amount of movement of the first movable core, which is generated when the first movable core is attracted to the stationary core in response to the generation of the drive magnetic flux, is smaller than an amount of movement of the second movable core, which is generated when the second movable core is attracted to the stationary core after the movement of the first movable core.

4. The gas fuel injection valve according to claim 1, wherein:
the valve element is an outward-opening valve that is brought into a valve opening state when the valve element is moved toward an outside of the main body;
the first movable core has a contact portion that is configured to contact the second movable core when the first movable core is moved together with the second movable core at a valve opening time of the valve element; and
a cushioning portion is provided on a side of the second movable core opposite to the valve element to mitigate impact generated by abutment of the second movable core against the contact portion of the first movable core when the valve element is returned from the second lift position to the first lift position at the end of the fuel injection.

5. A fuel injection system comprising:
the gas fuel injection valve according to claim 1; and
a controller that includes a processor with a memory and is configured to control fuel injection by the gas fuel injection valve, wherein:
the controller is configured, at the end of the fuel injection, to perform energization control of the solenoid coil as a first control such that, from a state in which the first movable core and the second movable core are attracted to the stationary core, only the second movable core among the first movable core and the second movable core is separated from the stationary core, and the valve element is temporarily stopped at the first lift position, and, as a second control following the first control, to stop energization of the solenoid coil in a state where the valve element is stopped at the first lift position.

6. The fuel injection system according to claim 5, wherein after start of the energization of the solenoid coil, the controller is configured to perform energization control of the solenoid coil to supply a valve-opening current to the solenoid coil so that the first movable core and the second movable core are attracted to the stationary core, and thereby the valve element is lifted to the second lift position, and after the valve element is lifted to the second lift position, the controller is configured to perform energization control to supply a holding current, which is lower than the valve-opening current, to the solenoid coil so as to hold the valve element at the second lift position.

7. The fuel injection system according to claim 5, wherein:
the first movable core has a contact portion that is configured to contact the second movable core when the first movable core is moved together with the second movable core at a valve opening time of the valve element; and
as the first control, the controller is configured to perform the energization control of the solenoid coil so as to limit the first movable core from separating from the stationary core when the second movable core, which is separated from the stationary core, abuts against the contact portion of the first movable core.

8. The fuel injection system according to claim 5, wherein the controller is configured to variably set, based on a pressure of the gas fuel, a time period during which the first control is carried out.

9. The fuel injection system according to claim 5, wherein:
the main body includes a partition that partitions the fuel passage into an upstream side and a downstream side, wherein an upstream-side opening is formed through the partition, and the injection hole serves as a downstream-side opening;
the first movable core is integrated with an upstream-side valve element configured to open and close the upstream-side opening and is urged toward a valve closing side by a first spring;
the second movable core is integrated with a downstream-side valve element serving as the valve element and is urged toward a valve closing side by a second spring serving as the spring member;
when the first movable core is attracted to the stationary core in response to the generation of the drive magnetic flux, the upstream-side valve element and the downstream-side valve element are both moved to the first lift position, and thereafter, the second movable core is attracted to the stationary core by the drive magnetic flux, thereby the downstream-side valve element is moved to the second lift position; and
the controller is configured to perform:
a valve-closing speed reduction control that, at the end of the fuel injection, from the state in which the first movable core and the second movable core are attracted to the stationary core, after temporarily stopping the second movable core at the first lift position, returns the first movable core and the second movable core to the valve closing position, thereby reducing a valve closing speed of the downstream-side valve element; and
an injection cut-off improvement control that, at the end of the fuel injection, from the state in which the first movable core and the second movable core are attracted to the stationary core, stops the generation of the drive magnetic flux and returns the upstream-side valve element to the valve closing position by the urging force of the first spring, and thereafter returns the downstream-side valve element to the valve closing position by the urging force of the second spring, thereby improving injection cut-off; and
the controller is configured to selectively perform the valve-closing speed reduction control and the injection cut-off improvement control.
